(19) United States
(12) Patent Application Publication
(10) Pub. No.: US 2026/0326283 A1
(43) Pub. Date: Oct. 22, 2026

(54) AUTONOMOUS ROBOT AND METHODS FOR USING AN AUTONOMOUS ROBOT TO PERFORM A TASK

(71) Applicant: JIO Robotics LLC, Ellicot City, MD (US)

(72) Inventors: Jyothirmaye CHALLA, Ellicot City, MD (US); Edukondala Srinivas Reddy CHALLA, Ellicot City, MD (US); Sonalika CHALLA, Ellicot City, MD (US); Deekshika Reddy CHALLA, Ellicot City, MD (US)

(21) Appl. No.: 19/650,389

(22) Filed: Apr. 17, 2026

Related U.S. Application Data
(60) Provisional application No. 63/790,839, filed on Apr. 18, 2025.

(51) Int. Cl. B25J 5/00; B25J 9/16; B25J 13/00

(52) U.S. Cl. CPC B25J 5/007; B25J 9/1628; B25J 9/1676; B25J 13/003

(57) ABSTRACT

An autonomous robot for performing tasks is provided that includes a torso including arms and a waist. The torso is in an upright orientation about a vertical axis. Moreover, the robot includes a base attached to a wheel assembly. The wheel assembly is for moving the torso. The robot also includes a rotation mechanism that is positioned between and attached to the torso and the base. The rotation mechanism includes a housing and a platform. The platform includes a first motor for rotating the torso about the vertical axis through angles between zero and three-hundred-sixty degrees while the robot is operating. The housing includes a second motor for rotating the torso about a horizontal axis through angles between zero and forty-five degrees while the robot is operating.

### CROSS REFERENCE TO RELATED APPLICATIONS

This application claims the benefit of U.S. Provisional Patent Application No. 63/790,839, filed Apr. 18, 2025, the entire disclosure of which is incorporated herein by reference.

### BACKGROUND OF THE INVENTION

This invention relates generally to robots, and more specifically to autonomous robots and methods for using an autonomous robot to perform a task.

Manufacturers are known to face ongoing challenges in maintaining operational efficiency and labor availability. Manufacturing relies on manual labor to perform a wide variety of tasks. However, different laborers may perform to different standards and may use different techniques to perform the same and different tasks. As a result, manual labor is known to be associated with inconsistent product quality, inconsistent industrial operations, and increased operational costs. Additionally, it is known that laborers may not properly perform tasks due to fatigue. Fatigue and improper techniques are known to contribute to manufacturing inefficiencies, which make it difficult to consistently operate to economically produce high quality products.

Persistent labor shortages have been known to compound these challenges resulting in disrupted workflows, which result in variable product quality and incurring regulatory compliance risks. Labor shortages are known to effect many different types of manufacturing processes. Such manufacturing processes include, for example, loading and unloading manufactured items onto and from a conveyor belt, packaging items for transport to customers, and operating a commercial kitchen to meet required safety and hygienic standards.

Dishwashing methods in commercial kitchens generally rely on manual labor to clean, organize, and handle dishwashing tasks across different work areas within the kitchen. Manual dishwashing also introduces hygienic concerns, including cross-contamination, improper drying, and errors in chemical-based sanitation, which pose serious risks to food safety. Thus, it can be seen that using manual labor can result in inconsistent cleaning, increased operational costs, and increased sanitation risks. Human fatigue, improper dishwashing techniques and chemical mismanagement contribute to inefficiencies making it difficult to maintain standardized hygienic practices in commercial kitchens.

Thus, it would be advantageous and an improvement over the relevant technology to provide an autonomous robot and a method for using the autonomous robot to perform a task that implement consistent industrial operations that result in quickly, efficiently, and consistently manufacturing products of uniformly high quality and adhering to strict sanitation standards.

### BRIEF DESCRIPTION OF THE INVENTION

In one aspect of the present disclosure, an autonomous robot for performing tasks is provided that includes a torso including arms and a waist. The torso is in an upright orientation about a vertical axis. Moreover, the robot includes a base attached to a wheel assembly. The wheel assembly is for moving the torso. The robot also includes a rotation mechanism that is positioned between and attached to the torso and the base. The rotation mechanism includes a housing and a platform.

The platform includes a first motor for rotating the torso about the vertical axis through angles between zero and three-hundred-sixty degrees while the robot is operating. The housing includes a second motor for rotating the torso about a horizontal axis through angles between zero and forty-five degrees while the robot is operating.

In another aspect of the present disclosure, a method of using an autonomous robot to perform a task is provided that includes receiving, by an autonomous robot, a command to perform a task. The robot includes sensors, a torso attached to and rotatable about a base, arms, hands, and fingers. The torso is in an upright orientation about a vertical axis. Moreover, the method includes operating the sensors to locate at least one object required for performing the task.

In response to determining the sensors failed to detect the at least one object, the method includes rotating the torso about the vertical axis between one and three-hundred-sixty degrees while operating the sensors. In response to determining the sensors detected the at least one object, the method includes rotating the torso about a horizontal axis out of the upright position through angles between zero and forty-five degrees.

Moreover, the method includes grasping the at least one object with a hand, rotating the torso into the upright orientation, and rotating the torso about the vertical axis into a position to perform the task.

### BRIEF DESCRIPTION OF THE DRAWINGS

FIG. 1 is a diagram illustrating a front view of an example autonomous robot for performing a task according to an embodiment of the present disclosure;

FIG. 2 is a diagram illustrating a front view of an example rotation mechanism;

FIG. 3 is a diagram illustrating the front view of the robot as shown in FIG. 1 further including a Cartesian coordinate system electronically superimposed thereon;

FIG. 4 is a diagram illustrating a top view of the robot in an example initial position while operating in a commercial kitchen;

FIG. 5 is a diagram illustrating the top view of the robot as shown in FIG. 4; however, the torso is rotated one hundred eighty degrees;

FIG. 6 is a diagram illustrating the top view of the robot as shown in FIG. 5; however, the torso is rotated another one hundred eighty degrees;

FIG. 7 is a schematic diagram illustrating rotation of the torso about an X-axis with respect to a Y-axis;

FIG. 8 is a schematic diagram of an example computing system for performing a task according to an embodiment of the present disclosure;

FIG. 9 is a detailed schematic diagram illustrating an example Artificial Intelligence (AI) processing unit for use in operating the robot to perform a task according to an embodiment of the present disclosure; and

FIG. 10 is a flowchart illustrating an example method and algorithm for performing a task according to an embodiment of the present disclosure.

### DETAILED DESCRIPTION OF THE INVENTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the example embodiments described herein can be made without departing from the spirit and scope of the present disclosure.

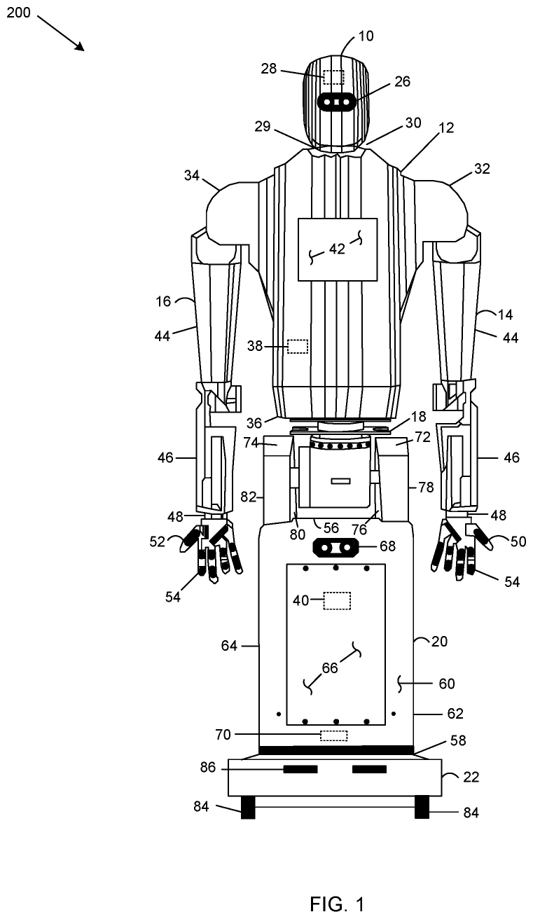

FIG. 1 is a diagram illustrating a front view of an example autonomous robot 200 for performing a task according to an embodiment of the present disclosure. More specifically, the robot 200 includes components, for example, a head 10, a torso 12, a left arm 14, a right arm 16, a rotation mechanism 18, a base 20, and a wheel assembly 22. The head 10 includes sensors, for example, a camera 26 and a distance sensor 28. The distance sensor 28 is located inside the head 10. Alternatively, the distance sensor 28 may be located anywhere inside the robot 200, for example, inside the torso 12. The distance sensor 28 is shown in dashed lines because it is located inside the head 10. The head 10 may also include a face and a light (not shown) in the face to illuminate the area around the robot 200.

The camera 26 is located in the face portion of the head 10 and can be considered a sensor in the robot 200. The camera 26 can be one or more imaging devices configured to record image data. The camera 26 may be a stereo camera which enhance object detection and depth perception. As used herein, capture means to record data temporarily or permanently, for example, image data and audio data. Audio data includes, for example, voice commands spoken by a person. Moreover, the camera 26 is capable of recording images under any lighting conditions including infrared light. The camera 26 may be integrated into the head 10 as one or more front-facing cameras and/or one or more rear facing cameras that each incorporates a sensor, for example and without limitation, a CCD or CMOS sensor. A rear facing camera 26 may be for capturing image data of objects behind the robot 200. The camera 26 may capture image data of objects in the environment surrounding the robot 200 during operation of the robot 200. Image data includes, for example, individual digital pictures, a series of individual pictures taken at different intervals of time, and a series of individual digital pictures taken at uniform intervals of time. A series of individual digital pictures taken at uniform intervals of time is a video.

It is contemplated by the present disclosure that the robot 200 may include additional sensors (not shown) that may also capture data while the camera 26 captures image data of objects. Such sensors include, but are not limited to, a sensor for detecting ambient light. The camera 26 may include at least one microphone, speakers, accelerometers, and gyroscopes. The microphone may be capable of receiving voice commands from a person for the robot 200 to perform a task.

The distance sensor 28 may be, for example a light detection and ranging (L.I.D.A.R.) device. Alternatively, the distance sensor 28 may be any type of device that can be fitted in the head 10 and is capable of dynamically detecting a distance between the distance sensor 28 and any objects that may be in the environment around the robot 200. The distance sensor 28 may detect distances in two and three-dimensions.

The head 10 is mounted on a servo motor 29 positioned on a top 30 of the torso 12 between the head 10 and the torso 12. Thus, the head 10 is able to rotate three-hundred sixty (360) degrees. The head 10 may alternatively, or additionally, include any type of sensors that enable the robot 200 to perform tasks as described herein. Other types of sensors may include, for example, audio sensors. The audio sensors may be located on the side of the head 10 proximate the typical location of ears on people. The audio sensors may be, for example, microphones capable of receiving voice commands spoken by a person.

The torso 12 includes the top 30, a left shoulder 32, a right shoulder 34, and a waist 36. The left arm 14 is rotationally and otherwise operationally connected to the left shoulder 32, while the right arm 16 is rotationally and otherwise operationally connected to the right shoulder 34. The left 32 and right 34 shoulders each include two rotary housing mounts (not shown) to facilitate rotation and operation of the left arm 14 and the right arm 16, respectively. The torso 12 may be hollow.

An inertial measurement unit (IMU) 38 may be located inside the torso 12. Because the IMU 38 is located inside the torso 12, it is shown in dashed lines. The IMU 38 facilitates linking the components of the robot 200 together. The IMU 38 is an electronic device that measures and reports the force of movement, angular rate, and orientation of the robot 200 using, for example, gyroscopes (not shown), accelerometers (not shown), and magnetometers (not shown). The accelerometers and gyroscopes generate data regarding rotations and translation of the components that make up the robot 200 and transmit the data to, for example, an artificial intelligence (AI) processing unit 40. Because the AI processing unit 40 is located inside the torso 12, it is shown in dashed lines. Magnetometers generate data regarding the direction, strength, or relative change of a magnetic field at a particular location in the robot 200. The torso 12 includes an interface/display 42 which may function as both a user interface and a display.

The left 14 and right 16 arms mimic the structure and mobility of a human arm. More specifically, each of the arms 14, 16 includes a humerus 44, a forearm 46, a wrist 48 and a hand. The left arm 14 includes a left hand 50 and the right arm 16 includes a right hand 52. Each hand 50, 52 includes four fingers and a thumb that can operate similar to those of people. The fingers and the thumbs include tactile sensors 54 that provide data regarding real-time touch sensing. Instead of four fingers and a thumb, each hand 50, 52 may alternatively include, for example, any number of fingers. Instead of fingers and a thumb, each hand 50, 52 may include grippers. The fingers may each have three folding segments similar to human fingers. Alternatively, each finger may have any number of folding segments, for example, two.

The humerus 44 of each arm 14, 16 is attached to a respective shoulder 32, 34 and rotates along pitch and roll axes. The left arm 14 and the right arm 16 may rotate three hundred sixty degrees about the left shoulder 32 and the right shoulder 34, respectively. The humerus 44 of each arm 14, 16 includes a motor (not shown) to facilitate rotation and other movement of the respective arm 14, 16. Each arm includes an elbow that may rotate three hundred sixty degrees.

Each forearm 46 includes a second motor (not shown) that facilitates controlling the hands 50, 52 and fingers. The wrist 48 may rotate up to three hundred sixty degrees.

The base 20 is a housing that includes four sides, a top 56 and a bottom end 58. The base 20 is rectangular and may be hollow. The four sides include a front side 60, a left side 62, a right side 64, and a back side (not shown). The front side 60 includes a panel 66 that can be removed to access an interior of the base 20. The base 20 also includes a camera 68 located in the front side 60 between the top 56 of the base 20 and the panel 66. Alternatively, the camera 68 may be positioned at any location on the front side 60 of the base 20. The camera 68 may be the same as the camera 26 described herein.

Although the cameras 26, 68 are located in the face portion of the head 10 and the front side 60, respectively, as described herein, it is contemplated by the present disclosure that any number of cameras 26, 68 may be located anywhere inside or outside of the robot 200 that facilitates operating the robot 200 to perform tasks as described herein. For example, an additional camera 26 may be located on the back of the head 10 or on the back of the torso 12 while also being located in the face portion of the head 10.

A distance sensor 70 may also be positioned on an underside (not shown) of the base 20. The distance sensor 70 may be the same as the distance sensor 28. Because the distance sensor 70 is located inside the base 20, it is shown in dashed lines. Although the distance sensors 28, 70 are located in the head 10 and base 20, respectively, as described herein, it is contemplated by the present disclosure that any number of distance sensors 28, 70 may be located anywhere inside or outside of the robot 200 that facilitates operating the robot 200 to perform tasks as described herein. For example, an additional sensor 28 may be located on each side of the base 20 or on any side of the wheel assembly 22 while also being located in the head 10.

It is contemplated by the present disclosure that distance data captured by the distance sensors 28, 70 is primarily used by the robot 200 when operating to perform a task. The image data captured by the cameras 26, 68 is used to supplement the captured distance data to facilitate the robot to perform the task. For example, when the distance data fails to include information about a certain area in the area surrounding the robot 200, the captured image data may be used to provide information about the certain area.

The base 20 also includes a first supporting member 72 and a second supporting member 74. The first supporting member 72 extends orthogonally away from the top 56 proximate the left side 62 of the base 20. The second supporting member 74 extends orthogonally away from the top 56 proximate the right side 64 of the base. The first supporting member 72 has an interior side 76 and an exterior side 78. The interior side 76 includes an orifice (not shown) while the exterior side 78 is proximate to the left side 62 of the base 20. The second supporting member 74 also has an interior side 80 and an exterior side 82. The interior side 80 includes an engagement opening (not shown) while the exterior side 82 is proximate to the right side 64 of the base 20. The exterior side 78 and the exterior side 82 may alternatively be flush with the left side 62 and the right side 64, respectively.

The interior of the base 20 includes the artificial intelligence (AI) processing unit 40, a battery (not shown) and other components (not shown) necessary to operate and manage the power of the robot 200. The bottom 58 of the base 20 is fixedly attached to the wheel assembly 22. As a result, there is no rotation between the base 20 and the wheel assembly 22 during operation of the robot 200.

The wheel assembly 22 includes a four-wheel drive mechanism (not shown) that uses four wheels 84 for versatility and omnidirectional movement. The wheel assembly 22 may alternatively include a drive mechanism for any number of wheels, for example, a six-wheel drive mechanism. The wheels 84 may be, for example, mecanum wheels. The wheel assembly 22 also includes one or more infrared sensors 86 and a charging socket (not shown) that may be used to charge the battery in the base 20. The charging socket may be located anywhere on the wheel assembly 22, for example, beneath or next to the infrared sensors 86 or on a back of the wheel assembly 22. As a result, the socket enhances the operational efficiency and longevity of the robot 200. The wheel assembly 22 is for facilitating movement of the robot 200, specifically translation and rotation of the robot 200.

It is contemplated by the present disclosure that the head 10, torso 12, base 20 and wheel assembly 22 may alternatively have any shape, instead of the respective shapes described herein, that enables performing their respective functions as described herein. For example, the head 10 may alternatively be a cube, the torso 12 may alternatively be a sphere, the base may alternatively have a circular cross section and the wheel assembly 22 may alternatively be circular.

The rotation mechanism 18 is located between the torso 12 and the base 20 and facilitates rotating the torso 12 with respect to the base 20.

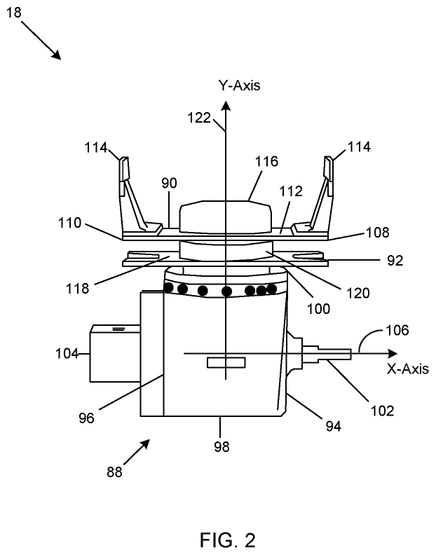

FIG. 2 is a diagram illustrating a front view of an example rotation mechanism 18. The rotation mechanism 18 includes a housing 88, a first platform 90, and a second platform 92. The exterior of the housing 88 has a rectangular cross section. As a result, the housing 88 has a first side 94, a second side 96, a bottom 98, and a top 100. The top 100 is open. An interior of the housing 88 may have any cross section, for example, square or circular. A motor (not shown) is positioned within an interior of the housing 88. An axle 102 of the motor extends from the interior of the housing 88 through the first side 94 and orthogonally away from the first side 94.

The second side 96 of the housing 88 includes a housing member 104 extending orthogonally away from the second side 96. The housing member 104 has a square cross section, but may alternatively have any cross section that facilitates rotating the torso 12 as described herein. A longitudinal axis 106 of the axle 102 coincides with a longitudinal axis of the member 104. Thus, the longitudinal axis 106 defines a first axis of rotation of the rotation mechanism 18.

The first 90 and second 92 platforms are rotatably connected to the housing 88. The first platform 90 has an elongated rectangular shape and includes a first end 108, a second end 110, a top surface 112 and a bottom surface (not shown). The first 108 and second 110 ends each include a leg 114 that extends away from the top surface 112. A first platform motor 116 is positioned on the top surface 112.

The second platform 92 is located between the first platform 90 and the top 100 of the housing 88. The second platform 92 has an elongated rectangular shape and a top surface 118. A second platform motor 120 is mounted on the top surface 118. It should be understood that the second platform motor 120 is positioned between the bottom surface (not shown) of the first platform 90 and the top surface 118 of the platform 92. Each of the first 116 and second 120 platform motors rotates about a center of the respective motor. A vertical axis 122 may be defined by the centers of rotation of the motors to define a second axis of rotation of the rotation mechanism 18.

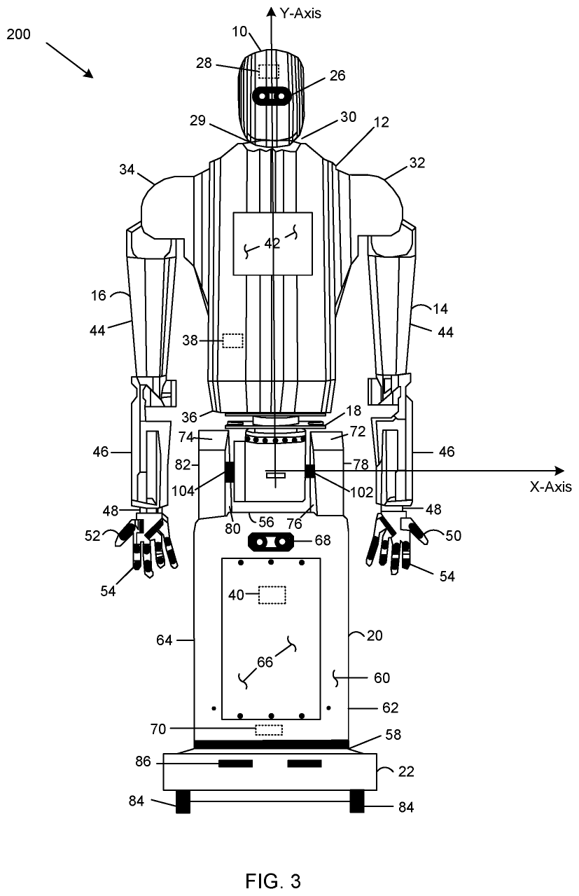

The information shown in FIG. 3 includes the same information shown in FIG. 1 as described in more detail below. As such, features illustrated in FIG. 3 that are identical to features illustrated in FIG. 1 are identified using the same reference numerals used in FIG. 1.

FIG. 3 is a diagram illustrating the front view of the robot 200 as shown in FIG. 1 further including the Cartesian coordinate system superimposed thereon. The Cartesian coordinate system has X and Y-axes and is superimposed on the rotation mechanism 18 such that the longitudinal axis 106 coincides with the X-axis of the Cartesian coordinate system and the axis 122 coincides with the Y-axis. The rotation mechanism 18 is positioned and fitted between the torso 12 and the base 20. The torso 12 is in an upright orientation about the Y-axis.

The rotation mechanism 18 is attached to the torso 12 by inserting the legs 114 into the waist 36 of the torso 12 such that the legs 114 engage an interior surface of the torso 12. Thus attached, the first platform motor 116 is positioned within the torso 12. The rotation mechanism 18 is attached to the base 20 by fitting the axle 102 into the orifice (not shown) in the interior side 76 of the first supporting member 72, and fitting the housing member 104 into the engagement opening (not shown) in the interior side 80 of the second supporting member 74. By thus attaching the rotation mechanism 18 to the torso 12 and the base 20, the torso 12 is enabled to rotate about the X and Y-axes with respect to the base 20.

Although the rotation mechanism 18 is attached to the torso 12 via the legs 114, it is contemplated by the present disclosure that the rotation mechanism 18 may alternatively be attached to the torso 12 in any manner, for example, using an adhesive or by welding.

The torso 12 may rotate with respect to the base 20 and about the Y-axis by three-hundred-sixty degrees. The torso 12 may rotate in the clockwise direction about the Y-axis. Additionally, the torso 12 may rotate about the X-axis with respect to the base 20 by up to forty-five degrees. It should be understood that the orientation of the base 20 with respect to the rotation mechanism does not change while the torso 12 rotates about the X and Y-axes. The rotation mechanism 18 may operate so that the torso 12 simultaneously rotates about the X and Y-axes.

Although the torso 12 rotates clockwise about the Y-axis with respect to the base 20 as described herein, it is contemplated by the present disclosure that the torso 12 may alternatively rotate clockwise only or may rotate both clockwise and counterclockwise about the Y-axis with respect to the base 20.

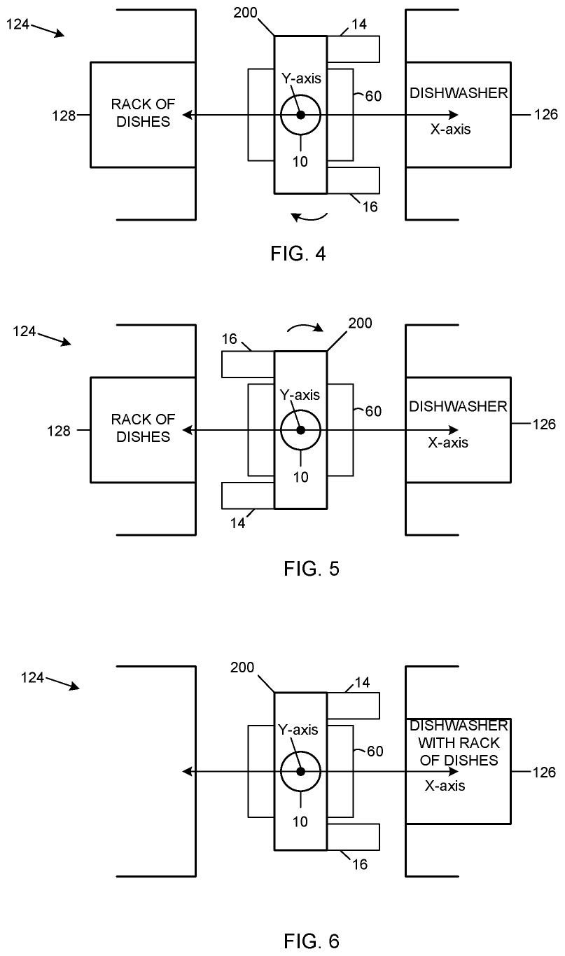

FIG. 4 is a diagram illustrating a top view of the robot 200 in an example initial position while operating in a commercial kitchen 124. The X and Y-axes described herein with regard to FIG. 3 are superimposed on the robot 200. The Y-axis goes into and out of the page. In the initial position, before receiving a command to perform a task, the robot 200 faces a dishwasher 126. Upon receiving a command, for example, to place a rack of dishes 128 in the dishwasher 126, sensors of the robot 200 capture data which is processed to evaluate objects in the environment around the robot 200 in an effort to locate the rack of dishes 128. In response to determining that objects relating to the rack of dishes 128 have not been detected in the initial position, the torso 12 of the robot 200 rotates clockwise about the Y-axis with respect to the base 20 to continue attempting to detect objects relating to the rack of dishes 128. The orientation of the base 20 with respect to the rotation mechanism 18 remains the same while the torso 20 rotates with respect to the base 20. However, it is contemplated by the present disclosure that the base 20 may translate while maintaining the same orientation with the rotation mechanism 18. As a result, the base 20 and the torso 12 may simultaneously translate and rotate, respectively.

The information shown in FIGS. 5 and 6 includes the same information shown in FIG. 4 as described in more detail below. As such, features illustrated in FIGS. 5 and 6 that are identical to features illustrated in FIG. 4 are identified using the same reference numerals used in FIG. 4.

FIG. 5 is a diagram illustrating the top view of the robot 200 as shown in FIG. 4. However, the torso 12 has rotated one hundred eighty degrees clockwise to face the rack of dishes 128. The base 20 is in the same orientation as shown in FIG. 4. Upon detecting an object related to the rack of dishes 128, the torso 12 stops rotating about the Y-axis and starts rotating about the X-axis to lean towards the rack of dishes 128. The torso 12 may rotate up to forty-five degrees about the X-axis. Next, the robot 200 moves one of the hands 50, 52 proximate the detected object and uses the tactile sensors 54 to collect data about the position of the object. Based on the data collected by the sensors 54, the robot 200 determines a pressure to apply by the fingers when grasping the object. The robot 200 grasps the rack of dishes 128 and the torso 12 rotates clockwise about the y-axis with respect to the base 20 to face the dishwasher 126.

FIG. 6 is a diagram illustrating the top view of the robot 200 as shown in FIG. 5 after the torso 12 rotated another one hundred eighty degrees with respect to the base 20 to face the dishwasher 126. Next, the robot 200 opens the dishwasher 126 to place the rack of dishes 128 in the dishwasher 126, close the dishwasher 126, and starts the dishwasher 126.

Although the task described herein as being performed by the robot 200 is for moving a rack of dishes 128 and operating the dishwasher 128, it is contemplated by the present disclosure that the robot 200 may additionally perform different tasks for different industries. For example, the robot 200 may place a manufactured item, for example, an automobile tire rim on a conveyor belt as part of an industrial manufacturing process and may retrieve tire rims from the conveyor belt before packaging them for transport or installing them on an automobile. As another example, the robot 200 may weld parts on a computer motherboard before placing the motherboard on a conveyor belt. Such motherboards may also be retrieved from the conveyor belt by the robot 200 and placed by the robot 200 in a box for transport. Additionally, the robot 200 may retrieve a bottle of pills from a conveyor belt and place the bottle in a box for packaging. Thus, the robot 200 may be used in industries such as, but not limited to, automobile manufacturing, computer manufacturing, and medicine manufacturing and production.

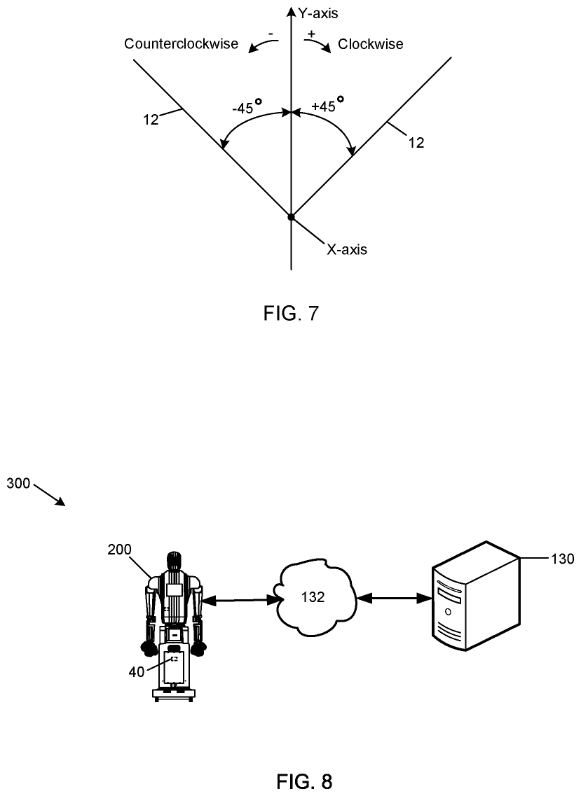

FIG. 7 is a schematic diagram illustrating rotation of the torso 12 about the X-axis. The X-axis goes into and out of the page. The torso 12 may rotate about the X-axis a maximum of forty-five degrees with respect to the Y-axis in the positive (+) and negative (−) directions. The positive direction is clockwise and the negative direction is counterclockwise. It should be understood that by rotating in the positive (+) direction, the robot 200 leans forward and by rotating in the negative (−) direction the robot 200 leans backwards.

FIG. 8 is a schematic diagram of an example computing system 300 for using the autonomous robot 200 to perform a task according to an embodiment of the present disclosure. As shown in FIG. 8, the main elements of the system 300 include the robot 200 and a server 130 communicatively connected via a network 132.

The server 130 can be, for example, any type of server or computer implemented as a network server or network computer. The robot 200 and server 130 may alternatively be referred to as information systems or electronic devices. It is contemplated by the present disclosure that the AI processing unit 40, the server 130, electronic devices (not shown) and computers (not shown) in the computer system 300 may be implemented in a cloud environment.

The network 132 may be implemented as a 5G communications network. Alternatively, the network 132 may be implemented as any wireless network including, but not limited to, 4G, 3G, Wi-Fi, Global System for Mobile (GSM), Enhanced Data for GSM Evolution (EDGE), and any combination of a LAN, a wide area network (WAN) and the Internet. The network 132 may also be any type of wired network or a combination of wired and wireless networks.

It is contemplated by the present disclosure that the number of robots 200 and servers 130 is not limited to the number shown in the system 300. Rather, any number of robots 200 and servers 130 may be included in the system 300.

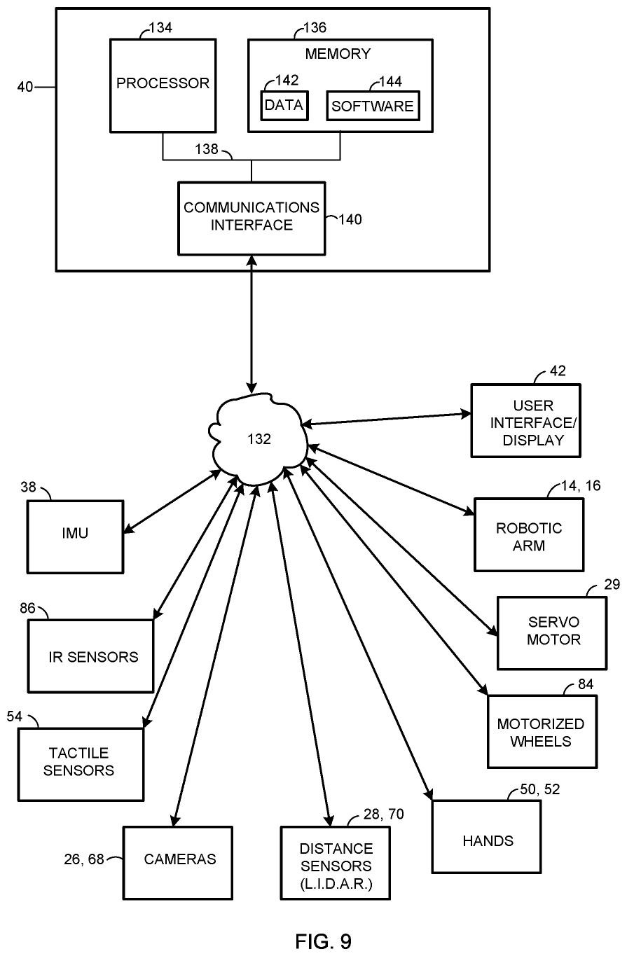

FIG. 9 is a detailed schematic diagram illustrating an example Artificial Intelligence (AI) processing unit 40 for using the robot 200 to perform a task according to an embodiment of the present disclosure. The AI processing unit 40 includes components such as, but not limited to, one or more processors 134, a memory 136, a bus 138, and a communications interface 140. General communication between the components in the AI processing unit 40 is provided via the bus 138. It is contemplated by the present disclosure that the AI processing unit 40 may be implemented, for example, as a system on a chip.

The processor 134 executes software instructions, or computer programs, stored in the memory 136. It is contemplated by the present disclosure that the number of processors 134 is not limited to the number shown in the AI processing unit 40. Rather, any number and type of processor(s) 134 may be included in the AI processing unit 40. As used herein, the term processor is not limited to just those integrated circuits referred to in the art as a processor, but broadly refers to a computer, a microcontroller, a microcomputer, a programmable logic controller, an application specific integrated circuit, a Tensor Processing Unit (TPU), a Graphics Processing Unit (GPU), and any other programmable circuit capable of executing at least a portion of the functions and/or methods described herein. The above examples are not intended to limit in any way the definition and/or meaning of the term “processor.”

The memory 136 may be any non-transitory computer-readable recording medium. Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), and disc drive or the like. Furthermore, the non-transitory computer-readable recording media may be implemented as smart cards, SIMs, any type of physical and/or virtual storage, or any other digital source such as a network or the Internet from which computer programs, applications or executable instructions can be read.

The memory 136 may be used to store any type of data 142, for example, commands to perform tasks, tasks, accelerometer generated data, gyroscope generated data, rotational data, data regarding objects in the environment around the robot 200, scene graphs, semantic maps, and metadata. Moreover, the memory 136 may store data generated by sensors, for example, image data captured by the cameras 26, 68 and distance data captured by the distance sensors 28, 70.

Additionally, the memory 136 can be used to store any type of software 144. As used herein, the term “software” is intended to encompass an executable computer program that exists permanently or temporarily on any non-transitory computer-readable recordable medium that causes, for example, the robot 200 to perform at least a portion of the functions, methods, and/or algorithms described herein. Application programs are software and include, but are not limited to, operating systems, Internet browser applications, object detection software, instance refinement software, trained large language models (LLM), path planning software, grasp pose detection software, object gripping and lifting software, grasp synthesis software, real-time force monitoring software, mapping software, navigation software, query processing software, motion prediction software, real-time scene analysis software, semantic mapping software, simultaneous localization and mapping (SLAM) software, and any other software and/or any type of instructions associated with algorithms, processes, or operations for controlling the general functions and operations of the robot 200. The software may also include computer programs that implement buffers and use RAM to store temporary data.

The object detection software facilitates processing real-time image captured by, for example, the camera 26 and analyzing each frame in the image data sequentially. The object detection software may also use a trained large language model (LLM) to apply instance-aware object detection to identify objects within a scene to incrementally map spatial and geometric relationships while the robot 200 attempts to perform a task. The object detection software facilitates, for example, classifying and assigning probabilistic labels through label fusion. Moreover, the object detection software facilitates creating a real-time semantic scene graph, and encoding objects and their relationships. The object detection software also facilitates, for example, generating bounding boxes around detected objects and classifying the detected objects using probabilistic label fusion to ensure accurate identification.

Data is validated by cross-referencing Red-Green-Blue-D inputs from captured image data to ensure accuracy. A complete refined semantic map enables the robotic 200 to efficiently navigate and execute tasks.

The instance refinement software facilitates, for example, refining segmentation errors in the spatial and geometric relationships.

Path planning software uses a scene graph and global semantic map to determine an optimal route between two points and ensures a collision-free local path for safe and efficient navigation of the robot 200 while performing a task.

Grasp pose detection software facilitates, for example, processing real-time image data on a frame-by-frame basis, and analyzing point cloud and depth data. The grasp pose detection software also leverages the object detection software to obtain a bounding box of a target object and calculates the optimal grasp position for precisely and securely picking-up an object.

Object gripping and lifting software receives data generated by the grasp pose detection software and may, for example, identify an optimal lifting point for an object. The object gripping and lifting software employs reinforcement learning to, for example, dynamically adjust a grip position and calculate a precise trajectory to lift the object safely and efficiently.

Grasp synthesis software facilitates, for example, calculating optimal grasp points, and selecting the appropriate precision, power, or adaptive grip based on the characteristics of an object.

Real-time force monitoring software facilitates ensuring that the robot 200 applies the correct pressure when gripping fragile objects like dishes or glasses.

Mapping software facilitates, for example, constructing high-resolution scene graphs, performing simultaneous localization and mapping (SLAM), and handling large-scale floor mapping to ensure adaptability to a variety of environments. A combination of semantic mapping software, motion prediction software, and real-time scene analysis software, facilitates determining the best approach for executing commands or tasks. Such software also facilitates continuously adapting to dynamic changes in the environment surrounding the robot 200, such as moving humans, new obstacles, or misplaced items.

Navigation software facilitates enabling the robot 200 to perform precise actions while implementing a command. Such actions include, but are not limited to, dishwashing, organizing, and cleaning tasks. The navigation software may be initiated using coordinates or zone-based data input by a person and generates an optimal path while actively avoiding obstacles. It is contemplated by the present disclosure that while the robot 200 is operating to perform a task or otherwise, the environment surrounding the robot 200 is continuously scanned. Scanned data may include, for example, image data captured by the cameras 26 and distance data captured by the distance sensors or L.I.D.A.R. sensors. The navigation software may use the captured sensor data to facilitate dynamically adjusting, in real-time, the path of the robot 200 while performing a task or otherwise operating. Such real-time adjustments ensure safe and efficient navigation of the robot 200. Upon arriving at a destination, the robot 200 verifies its position and confirms task completion.

The query processing software facilitates receiving voice commands spoken by a person through a microphone and converting the received voice command to text. The query processing software also queries a scene graph using an LLM model to interpret the received voice command. If the command cannot be understood, the query processing software prompts the person to speak the command again for clarification.

The user interface/display 42 may include an interface and a display and together they allow interaction between a person and the robot 200. The user interface/display 42 may be integrated into a touch screen display. Accordingly, the interface/display 42 may be used to show a graphical user interface, which can display various data and provide “forms” that include fields that allow for the entry of information by the user. Touching the screen at locations corresponding to the display of a graphical user interface allows the person to interact with the robot 200 to enter data, change settings, control functions, etc. Consequently, when the touch screen is touched, the user interface/display 42 communicates this change to the AI processing unit 40, and settings can be changed or user entered information can be captured and stored in the memory 136. The user interface/display 42 can be operated by a person to directly control the robot 200 by, for example, entering commands to perform a task and powering the robot 200 on and off. Alternatively, the robot 200 may be powered on and off by a person using a remote-control device.

The robot 200 may alternatively not include the interface/display 42. When the robot 200 does not include the user interface/display 42, the user interface/display 42 is/are separate from the robot 200 but can communicate with the robot 200 via the network 132. Such a separate user interface and display may display information. The display may be, for example, a Liquid Crystal Display (LCD), an active matrix display, plasma display, or cathode ray tube (CRT). The user interface may include a keypad, a camera, a keyboard, a mouse, an illuminator, a signal emitter, at least one microphone, for example, dual microphones, and/or speakers. A person may use such an interface to, for example, enter commands and power the robot 200 on and off.

Communications between the AI processing units 40 and other devices (not shown) may occur via NFC, RFID, Bluetooth or the like only so a network connection from the robot 200 is unnecessary.

The communications interface 140 may include various network cards, and circuitry implemented in software and/or hardware to enable wired and/or wireless communications with other electronic devices (not shown) via a network 132.

Communications include, for example, conducting cellular telephone calls and accessing the Internet over the network. By way of example, the communications interface 140 may be a digital subscriber line (DSL) card or modem, an integrated services digital network (ISDN) card, a cable modem, or a telephone modem to provide a data communication connection to a corresponding type of telephone line. As another example, the communications interface 140 may be a local area network (LAN) card (e.g., for Ethemet™ or an Asynchronous Transfer Model (ATM) network) to provide a data communication connection to a compatible LAN. As yet another example, the communications interface 140 may be a wire or a cable connecting the robot 200 with a LAN, or with accessories such as, but not limited to, other electronic devices. Further, the communications interface 140 may include peripheral interface devices, such as a Universal Serial Bus (USB) interface, a PCMCIA (Personal Computer Memory Card International Association) interface, and the like.

The communications interface 140 also allows the exchange of information across the network 132. The exchange of information may involve the transmission of radio frequency (RF) signals through an antenna (not shown). Moreover, the exchange of information may be between the robot 200 and other electronic devices (not shown), and other computer systems (not shown) capable of communicating over the network 132.

The electronic devices (not shown) may be associated with any user or with any type of entity including, but not limited to, commercial and non-commercial entities.

The AI Processing unit 40 may communicate with the user interface/device 42, the robotic arms 14, 16, servo motor 29, motorized wheels 84, hands 50, 52, distance sensors 28, 70, cameras 26, 68, tactile sensors 54, infrared sensors 86, IMU 38, the server 130, and any other electronic device (not shown) via the network 132 to operate the robot 200 to autonomously perform a task in response to receiving a command according to an embodiment of the present disclosure. A command may be entered via the user interface/display 42 by a person, for example, typing the command or speaking the command.

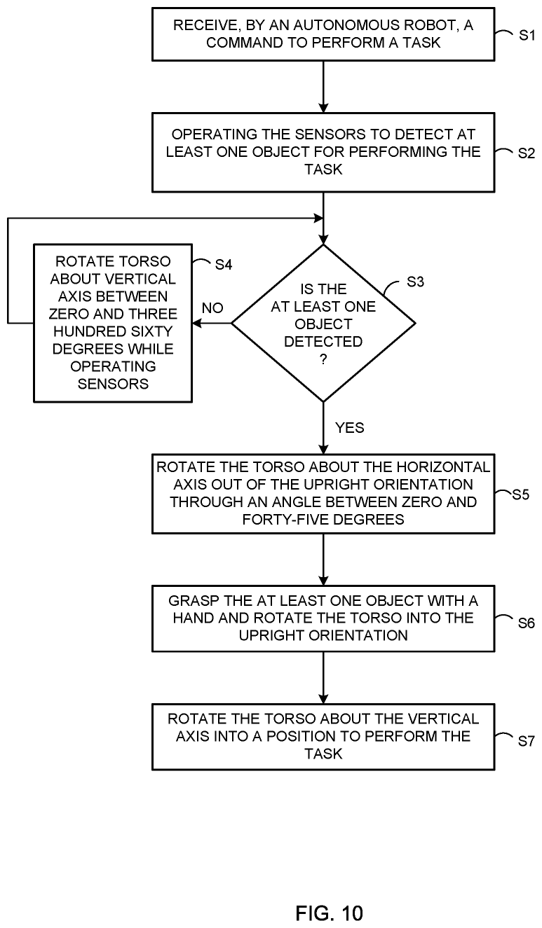

FIG. 10 is a flowchart illustrating an example method and algorithm for using an autonomous robot to perform a task according to an embodiment of the present disclosure. This method and algorithm may be implemented, for example, in response to receiving a command from a person operating a robot. The robot may be, for example, the robot 200 described herein with regard to FIGS. 1, 2, and 3. The command may be input into or received by a user interface of the robot 200 or remotely received from an electronic device (not shown) in the computer system 300. FIG. 10 illustrates example steps performed when the processor 134 runs software 144 stored in the memory 136 to cause the autonomous robot to perform a task.

In step S1, the software 144 executed by the

processor 134 causes the robot 200 to receive a command to perform a task. The command may be, for example, a voice command spoken by a person or a command entered by a person via the user interface/display 42. Alternatively, the command may be received via the network 132 from an electronic device (not shown) operated by the person. The command may be, for example, to place the rack of dishes 128 in the dishwasher 126. Alternatively, a task stored in the memory 136 may be performed.

The robot 200 includes sensors, a torso attached to and rotatable about a base, arms, hands and fingers. The sensors, torso, arms, hands and fingers may be those described herein for the robot 200 in regards to FIGS. 1, 2 and 3. The torso can be in an upright orientation about a vertical axis.

Next, in step S2, the software 144 executed by the processor 134 causes the robot 200 to operate the sensors to locate at least one object required for performing the task. In step S3, the software 144 executed by the processor 134 causes the robot 200 to determine whether or not the at least one object has been detected. In response to determining that the sensors failed to detect the at least one object, in step S4, the software 144 executed by the processor 134 causes the robot 200 to rotate the torso about the vertical axis with respect to the base 20 up to three hundred sixty degrees while operating the sensors to detect the at least one object. In response to determining the sensors detected the at least one object, in step S5, the software 144 executed by the processor 134 causes the robot 200 to rotate the torso about a horizontal axis through an angle up to forty-five degrees. Doing so causes the robot 200 to lean forward towards the at least one object.

Next, in step S6, the software 144 executed by the processor 134 causes the robot 200 to grasp the at least one object with a hand, and to rotate the torso into the upright orientation. In step S7, the software 144 executed by the processor 134 causes the robot 200 to rotate the torso about the vertical axis relative to the base 20 into a position to perform the task.

Using the methods and algorithms for using an autonomous robot to perform a task as described herein enhances the consistency and efficiency of industrial operations, and facilitate enhancing the quality of manufactured products and the consistency of product quality. As a result, purchaser satisfaction is facilitated to be enhanced while manufacturing time and costs are facilitated to be reduced.

It is contemplated by the present disclosure that the example methods and algorithms described herein may be conducted entirely by the robot 200, or partly by the robot 200 and partly by the server 130. Furthermore, data described herein as being stored in the robot 200 may alternatively, or additionally, be stored in any other server (not shown), electronic device (not shown), or computer (not shown) operable to communicate with the robot 200 via the network 132.

Additionally, the example methods and algorithms described herein may be implemented with any number and organization of computer program components. Thus, the methods and algorithms described herein are not limited to specific computer-executable instructions. Alternative example methods and algorithms may include different computer-executable instructions or components having more or less functionality than described herein.

The example methods and/or algorithms described above should not be considered to imply a fixed order for performing the method and/or algorithm steps. Rather, the method and/or algorithm steps may be performed in any order that is practicable, including simultaneous performance of at least some steps. Moreover, the method and/or algorithm steps may be performed in real time or in near real time. It should be understood that for any method and/or algorithm described herein, there can be additional, fewer, or alternative steps performed in similar or alternative orders, or in parallel, within the scope of the various embodiments, unless otherwise stated. Furthermore, the invention is not limited to the embodiments of the methods and/or algorithms described above in detail.

What is claimed is:

1. An autonomous robot for performing tasks comprising:
a torso including arms and a waist, the torso being in an upright orientation about a vertical axis;
a base attached to a wheel assembly, the wheel assembly for moving the torso; and
a rotation mechanism, the rotation mechanism being positioned between and attached to the torso and the base, the rotation mechanism including a housing and a platform, wherein
the platform includes a first motor for rotating the torso about the vertical axis through angles between zero and three-hundred-sixty degrees while the robot is operating, and
the housing includes a second motor for rotating the torso about a horizontal axis through angles between zero and forty-five degrees while the robot is operating.

2. The autonomous robot according to claim 1, the housing comprising:
a first side;
a second side;
an axle extending orthogonally away from the first side; and
a housing member extending orthogonally away from the second side.

3. The autonomous robot according to claim 2, the base comprising:
a base housing having a first side, a second side, a top, and a bottom end, the bottom end being attached to the wheel assembly;
a first supporting member; and
a second supporting member, each supporting member extending orthogonally away from the top, the first supporting member including an orifice, the second supporting member including an engagement opening, wherein the housing member is fit in the engaging opening and the axle is fit within the orifice to attach the rotation mechanism to the base and create the horizontal axis about which the robot is rotated.

4. The autonomous robot according to claim 1, wherein:
the torso is hollow and includes a waist;
the housing includes a top side; and
the platform includes a first platform and a second platform, the first motor includes a first sub-motor mounted on the first platform and a second sub-motor mounted on the second platform, the first platform is attached to the waist of the torso, the first sub-motor is positioned inside the torso, and the second sub-motor is positioned outside of the torso.

5. The autonomous robot according to claim 1, wherein the first and second motors rotate the torso at variable speeds.

6. The autonomous robot according to claim 1, wherein:
the torso includes a user interface for receiving commands input by a person;
a microphone for receiving voice commands from the person; and
the first and second motors rotate the torso while implementing the command.

7. A method of using an autonomous robot to perform a task comprising the steps of:
receiving, by an autonomous robot, a command to perform a task, the robot including sensors, a torso attached to and being rotatable about a base, arms, hands, and fingers, the torso being in an upright orientation about a vertical axis;
operating the sensors to locate at least one object required for performing the task;
in response to determining the sensors failed to detect the at least one object, rotating the torso about the vertical axis between one and three-hundred-sixty degrees while conducting said operating step;
in response to determining the sensors detected the at least one object, rotating the torso about a horizontal axis out of the upright position through angles between zero and forty-five degrees;
grasping the at least one object with a hand;
rotating the torso into the upright orientation; and
rotating the torso about the vertical axis into a position to perform the task.

8. The method according to claim 7, wherein the command is a voice command spoken by a person or a command entered into the robot using a user interface.

9. The method according to claim 7, said operating step comprising capturing sensor data to detect obstacles and recognize objects.

10. The method according to claim 7, wherein the fingers include tactile sensors, said grasping step comprising:
moving one of the hands proximate the at least one object;
collecting, by the tactile sensors, data about the position of the at least one object; and
determining, based on the data collected by the tactile sensors, a pressure to apply by the fingers when grasping the at least one object.

11. The method according to claim 7, said rotating the torso about the vertical axis comprises rotating the torso at a constant or variable speed.

12. The method according to claim 7, further comprising using semantic mapping, motion prediction and real-time scene analysis to determine a best approach for completing the task.
